(19) United States
(12) Patent Application Publication
(10) Pub. No.: US 2023/0416660 A1
(43) Pub. Date: Dec. 28, 2023

(54) Vacuum Distillation Process for Cocktails

(71) Applicant: Still Civil Inc., Toronto (CA)

(72) Inventors: Nick KENNEDY, Toronto (CA); James TURCO, Toronto (CA)

(21) Appl. No.: 18/340,185

(22) Filed: Jun. 23, 2023

Related U.S. Application Data
(60) Provisional application No. 63/355,137, filed on Jun. 24, 2022.

(51) Int. Cl. C12G 3/06

(52) U.S. Cl. CPC C12G 3/06

(57) ABSTRACT

A method of extracting volatile flavor compounds from an organic material. The method includes a step of macerating the organic material in a solution containing ethanol. The ethanol is then boiled at a pressure that is less than atmospheric pressure, to produce a vapor. The vapor is then passed through a first condenser to generate a first condensate, and through a second condenser to generate a second condensate, with the second condenser operating at a lower temperature than the first condenser.

### RELATED APPLICATION

This application claims priority to the 24 Jun. 2022 filing date of U.S. Patent Application Ser. No. 63/355,137, which is incorporated herein by reference.

### FIELD OF THE INVENTION

This invention relates to methods of manufacturing cocktails, and more particularly to the use of vacuum distillation to produce ready-to-drink shelf-stable cocktails.

### BACKGROUND OF THE INVENTION

Cocktails are traditionally made by an attending bartender or enthusiast using purchased spirits, liquors and wines in combination with fresh organics such as juices, fruits and peels with the addition of dilution in the form of ice. This results in a beverage with highly volatile aromas and unique esters, but with a very limited shelf life.

Current manufacturing techniques used to replicate the creation of cocktails either use a variety of inorganic acids and synthetic flavor compounds to replicate the final cocktail, or rely on consumers adding their own volatile organics to the product to complete the cocktail.

Traditional distillation is done using temperatures in excess of 70 degrees Celsius, resulting in the separation of ethanol vapors from the mixture. A byproduct of these heating conditions is that many organic compounds are catalyzed or otherwise degraded. While these products may be used in the creation of a cocktail, they are not the highly volatile or flavorful component of the beverage. Previous manufacturing of shelf-stable cocktails used infused spices, sugars and synthetic flavors to recreate the volatility and vibrance consumers expect in a cocktail.

### SUMMARY OF THE INVENTION

To at least partially overcome some of the disadvantages of previously known methods and devices, in one aspect the present invention provides a method of extracting volatile flavor compounds from an organic material. The method includes a step of macerating the organic material in a solution containing ethanol. The ethanol is then boiled at a pressure that is less than atmospheric pressure, to produce a vapor. The vapor is then passed through a first condenser to generate a first condensate, and through a second condenser to generate a second condensate, with the second condenser operating at a lower temperature than the first condenser. The first condensate and the second condensate can then be collected and used, for example, to manufacture a ready-to-drink shelf-stable cocktail, which preferably contains volatile flavor compounds extracted from the organic material.

In especially preferred embodiments, the solution contains about 20% ethanol by volume; the mixture of the organic material and the solution contains about 10% to 20% organic material by weight; the pressure is between about 2 and 20 Torr; the ethanol is boiled at a temperature between about 20 and 45 degrees Celsius; the first condenser operates at a temperature of about −4 degrees Celsius; and the second condenser operates at a temperature of about −40 degrees Celsius.

The applicant has appreciated that by distilling the solution at a reduced pressure, the ethanol can be boiled at a lower temperature, thereby protecting the volatile flavor compounds from becoming degraded at higher temperatures. Preferably, the boiling temperature does not exceed the highest temperature that the organic material was exposed to before the distillation process. For example, if the organic material is an orange, the distillation preferably does not exceed the highest temperature that an orange would normally be exposed to (e.g. the highest temperature normally experienced during the growing season in Florida).

The applicant has further appreciated that by using two condensers operating at different temperatures, the efficiency and yield of the distillation process can preferably be improved. In particular, the first condenser preferably operates at a relatively high temperature, such as −4 degrees Celsius, and is able to condense much of the ethanol and volatile flavor compounds from the vapor, while substantially lowering the temperature of any remaining vapor. The second condenser preferably operates at a much lower temperature, such as −40 degrees Celsius, and is preferably able to condense all of the remaining ethanol and volatile flavor compounds from the vapor. This not only improves the yield of the distillation process, but also protects any downstream components (e.g. a vacuum pump) from becoming contaminated by ethanol.

In preferred embodiments, the invention uses a unique water to ethanol ratio for the maceration of volatile organic materials, then distills this mixture in extremely low barometric conditions with the use of a vacuum pump to separate out the ethanol and volatile components in the form of a gas. This gas is then condensed in a unique two stage heat exchange system. The spirit produced is then blended with acidifying agents, other alcoholic products, and water in specifically designed tanks.

The results are preferably pasteurized using ultra violet light to preserve the volatile organics and flavor compounds. The cumulative result of this process can generally be characterized as a cocktail that is highly volatile, does not require any modification, is shelf-stable, and ready to consume.

The invention leverages vacuum distillation to create highly volatile spirits as the base for the creating of shelf-stable cocktails. By inventing a unique vacuum distillation system, distillation can occur in a temperature range between 20 and 45 degrees Celsius, ensuring delicate organic flavors are extracted with minimal change. Additionally, condensation of the distillate occurs in the process in two distinct phases to ensure maximal retention of flavors and ethanol.

The preparation of these organic components such as stone fruits, citrus fruits, berries, flowers, seeds, nuts, vegetables, herbs, dairy products, honeys, agricultural byproducts, fresh herbs, aromatics and grains are preferably treated as follows. An infusion is prepared consisting of 10 to 20 percent flavored ingredient in a 20 percent alcohol by volume medium, left to infuse for between 24 and 72 hours. In some embodiments of the invention, it is preferred that the organic components macerate for at least 48 hours, and no more than 7 days.

Once the mixture has completed its infusion period it is distilled in a vacuum and condensed. Distillation preferably occurs at a pressure of between 2 and 20 Torr, to reduce the boiling point of the alcoholic medium. The product being distilled is indirectly heated to temperatures preferably between 22 and 48 degrees Celsius to begin the distillation process. Once vaporization occurs the system is preferably controlled through management of barometric pressure instead of temperature. In particular, the pressure may be reduced over time as the ethanol boils out of the solution, in order to maintain boiling. This may be achieved by visually monitoring the solution and adjusting the pressure to maintain boiling, or more preferably is achieved by an automated system that detects boiling and adjusts the pressure automatically. The process is completed once the ethanol has been stripped from the infused mixture. Preferably the temperature remains constant throughout the boiling. Preferably, a jacketed heating system is used to maintain a constant temperature.

Condensation of the ethanol rich vapors occurs in two stages. The first stage is a glycol heat exchanger preferably operated at about −4 degrees Celsius. Condensed liquid is collected in an insulated vessel. A second liquid salt condenser preferably operating at about −40 degrees Celsius is used to condense the remaining flavonoids and ethanol present in the system before they can reach the vacuum pump. This two stage condensation system ensures minimal loss of both ethanol and flavor.

The resulting spirit can be combined with other spirits, wines, or liqueurs to make cocktails designed to be packaged in bottle, can, cup or kegged formats.

In some cases, the addition of a unique blend of acidifying ingredients may also be included, the blend being pasteurized kombucha, citric acid, and malic acid. Lactic acid and tartaric acid may also be included depending on the recipe being produced. This acid blend is a novel approach to recreating the flavor of fresh citrus juice.

Deoxygenated water may be used to dilute the cocktails between 10 to 22 percent total volume. This process is preferably titrated over a period of 24 hours, which preferably reduces the separation of free radicals and unbound flavonoids. A very slow titration process preferably helps to reduce the degradation of flavor compounds that might otherwise occur with rapid mixing.

Once blended and diluted, the product is preferably pasteurized using ultra violet light to ensure the minimal amount of degradation or catalyzation of flavor compounds. The process preferably stabilizes the flavors extracted by the vacuum distillation.

The final product is preferably a cocktail of exceptional quality and vibrancy, not currently achievable by existing manufacturing techniques.

The invention can also be used to produce non-alcoholic wines and beers. In particular, beer or wine may be used as the initial product (in place of the mixture of organic material and ethanol solution in the process as described above). The ethanol is then boiled out of the beer or wine at a pressure that is less than atmospheric pressure to produce a vapor, and the vapor is passed through the first condenser and the second condenser. Once all of the ethanol has been stripped from the beer or wine, the remaining beer or wine is non-alcoholic. Deoxygenated water can be used to replace any volume of water and/or ethanol lost from the beer or wine during the de-alcoholization process.

Accordingly, in one aspect the present invention resides in a method comprising: macerating an organic material in a solution containing ethanol; boiling the ethanol at a pressure that is less than atmospheric pressure to produce a vapor; passing the vapor through a first condenser to generate a first condensate; and passing the vapor through a second condenser to generate a second condensate; wherein the second condenser operates at a lower temperature than the first condenser.

Preferably, the solution contains less than 30% ethanol by volume; less than 25% ethanol by volume; or about 20% ethanol by volume.

Preferably, the organic material and the solution together form a mixture, wherein the organic material is less than 30% of the mixture by weight; or the organic material is between about 10% and 20% of the mixture by weight.

Preferably, the pressure is less than 40 Torr; less than 30 Torr; or between about 2 and 20 Torr.

Preferably, the pressure is adjusted over time to maintain boiling of the ethanol.

Preferably, the pressure is reduced over time to maintain boiling of the ethanol.

Preferably, the ethanol is boiled at a temperature that is less than 50 degrees Celsius; less than 40 degrees Celsius; between about 20 degrees Celsius and 45 degrees Celsius; between about 20 degrees Celsius and 42 degrees Celsius; or about 30 degrees Celsius.

Preferably, the first condenser operates at a temperature between about 0 degrees Celsius and about −10 degrees Celsius; between about 0 degrees Celsius and about −5 degrees Celsius; or about −4 degrees Celsius.

Preferably, the second condenser operates at a temperature below −30 degrees Celsius; or about −40 degrees Celsius.

In some embodiments, the invention provides a process for the manufacturing of ready-to-drink shelf stable cocktails comprised of the following steps: organics are macerated in an ethanol water solution of 20 percent; the distillation of this solution occurs under reduced barometric conditions controlled by vacuum pump; these conditions allow for lower operating temperatures ranging from 20 to 45 degrees Celsius; the condensate of the gases produced through this distillation is a spirit made using a two-stage heat exchanger that is comprised of one cryogenic temperature range vent condenser; pasteurization occurs through the use of ultra violet light; the results of this pasteurization and blending creates a highly volatile and aromatic cocktail that is shelf-stable.

In some embodiments, the use of a vacuum distillation is used for the creation of cocktails.

In some embodiments, volatility of a shelf-stable cocktail is achieved through the blend of vacuum distillates.

In some embodiments, volatile flavors are preserved through maceration in a mixture of 20 percent ethanol to water.

In some embodiments, two stages of heat exchanger are used in the condensation of vacuum distilled gases for the preparation of alcoholic beverages.

In another aspect, the invention resides in a process to prepare lime juice for incorporation into alcoholic beverages by the following method; 1) limes are pressed 2) Juice is collected and separated from husks 3) Lime Juice is concentrated at low temperature using changes in barometric pressure. The vapor from this concentration process is a hydrosol that is collected using a vacuum still and condenser to be used in the dilution of alcoholic beverages containing lime. 4) The concentrated lime juice has the pectin removed through enzymatic processing. 5) The husks are macerated in ethanol and water at an alcohol by volume of 20% alcohol by volume and left to macerate for 24 hours. 6) This macerated is vacuumed distilled and the concentrated ethanol and flavors are also used in alcoholic beverages containing lime. 7) The combination of vacuum concentrated lime juice, lime husk distillate, and lime hydrosol creates a shelf stable and highly desirable lime juice.

Further aspects of the invention include:

1. A method comprising: macerating an organic material in a solution containing ethanol; boiling the ethanol at a pressure that is less than atmospheric pressure to produce a vapor; passing the vapor through a first condenser to generate a first condensate; and passing the vapor through a second condenser to generate a second condensate; wherein the second condenser operates at a lower temperature than the first condenser.

2. A method, which optionally incorporates one or more features of any one or more of the preceding and/or following aspects, wherein the solution contains less than 30% ethanol by volume.

3. A method, which optionally incorporates one or more features of any one or more of the preceding and/or following aspects, wherein the solution contains less than 25% ethanol by volume.

4. A method, which optionally incorporates one or more features of any one or more of the preceding and/or following aspects, wherein the solution contains about 20% ethanol by volume.

5. A method, which optionally incorporates one or more features of any one or more of the preceding and/or following aspects, wherein the organic material and the solution together form a mixture; and wherein the organic material is less than 30% of the mixture by weight.

6. A method, which optionally incorporates one or more features of any one or more of the preceding and/or following aspects, wherein the organic material is between about 10% and 20% of the mixture by weight.

7. A method, which optionally incorporates one or more features of any one or more of the preceding and/or following aspects, wherein the pressure is less than 40 Torr.

8. A method, which optionally incorporates one or more features of any one or more of the preceding and/or following aspects, wherein the pressure is less than 30 Torr.

9. A method, which optionally incorporates one or more features of any one or more of the preceding and/or following aspects, wherein the pressure is between about 2 and 20 Torr.

10. A method, which optionally incorporates one or more features of any one or more of the preceding and/or following aspects, wherein the pressure is adjusted over time to maintain boiling of the ethanol.

11. A method, which optionally incorporates one or more features of any one or more of the preceding and/or following aspects, wherein the pressure is reduced over time to maintain boiling of the ethanol.

12. A method, which optionally incorporates one or more features of any one or more of the preceding and/or following aspects, wherein the ethanol is boiled at a temperature that is less than 50 degrees Celsius.

13. A method, which optionally incorporates one or more features of any one or more of the preceding and/or following aspects, wherein the ethanol is boiled at a temperature that is less than 40 degrees Celsius.

14. A method, which optionally incorporates one or more features of any one or more of the preceding and/or following aspects, wherein the ethanol is boiled at a temperature that is between about 20 degrees Celsius and 45 degrees Celsius.

15. A method, which optionally incorporates one or more features of any one or more of the preceding and/or following aspects, wherein the ethanol is boiled at a temperature that is about 30 degrees Celsius.

16. A method, which optionally incorporates one or more features of any one or more of the preceding and/or following aspects, wherein the first condenser operates at a temperature between about 0 degrees Celsius and about −10 degrees Celsius.

17. A method, which optionally incorporates one or more features of any one or more of the preceding and/or following aspects, wherein the first condenser operates at a temperature between about 0 degrees Celsius and about −5 degrees Celsius.

18. A method, which optionally incorporates one or more features of any one or more of the preceding and/or following aspects, wherein the first condenser operates at a temperature of about −4 degrees Celsius.

19. A method, which optionally incorporates one or more features of any one or more of the preceding and/or following aspects, wherein the second condenser operates at a temperature below −30 degrees Celsius.

20. A method, which optionally incorporates one or more features of any one or more of the preceding and/or following aspects, wherein the second condenser operates at a temperature of about −40 degrees Celsius.

21. A method, which optionally incorporates one or more features of any one or more of the preceding and/or following aspects, the method comprising: boiling ethanol out of an alcoholic beverage at a pressure that is less than atmospheric pressure.

22. A method, which optionally incorporates one or more features of any one or more of the preceding and/or following aspects, wherein the pressure is less than 40 Torr.

23. A method, which optionally incorporates one or more features of any one or more of the preceding and/or following aspects, wherein the pressure is less than 30 Torr.

24. A method, which optionally incorporates one or more features of any one or more of the preceding and/or following aspects, wherein the pressure is between about 2 and 20 Torr.

25. A method, which optionally incorporates one or more features of any one or more of the preceding and/or following aspects, wherein the pressure is adjusted over time to maintain boiling of the ethanol.

26. A method, which optionally incorporates one or more features of any one or more of the preceding and/or following aspects, wherein the pressure is reduced over time to maintain boiling of the ethanol.

27. A method, which optionally incorporates one or more features of any one or more of the preceding and/or following aspects, wherein the ethanol is boiled at a temperature that is less than 40 degrees Celsius.

28. A method, which optionally incorporates one or more features of any one or more of the preceding and/or following aspects, wherein the ethanol is boiled at a temperature that is less than 30 degrees Celsius.

29. A method, which optionally incorporates one or more features of any one or more of the preceding and/or following aspects, wherein the ethanol is boiled at a temperature that is less than 24 degrees Celsius.

30. A method, which optionally incorporates one or more features of any one or more of the preceding and/or following aspects, wherein the ethanol is boiled at a temperature that is about 20 degrees Celsius.

31. A method, which optionally incorporates one or more features of any one or more of the preceding and/or following aspects, wherein boiling the ethanol out of the alcoholic beverage generates a vapor, the method further comprising: passing the vapor through a first condenser and a second condenser; wherein the second condenser operates at a lower temperature than the first condenser.

32. A method, which optionally incorporates one or more features of any one or more of the preceding and/or following aspects, wherein the pressure that is less than atmospheric pressure is generated by a vacuum pump that is located downstream of the second condenser.

33. A method, which optionally incorporates one or more features of any one or more of the preceding and/or following aspects, wherein the first condenser operates at a temperature between about 0 degrees Celsius and about −10 degrees Celsius.

34. A method, which optionally incorporates one or more features of any one or more of the preceding and/or following aspects, wherein the first condenser operates at a temperature between about 0 degrees Celsius and about −5 degrees Celsius.

35. A method, which optionally incorporates one or more features of any one or more of the preceding and/or following aspects, wherein the first condenser operates at a temperature of about −4 degrees Celsius.

36. A method, which optionally incorporates one or more features of any one or more of the preceding and/or following aspects, wherein the second condenser operates at a temperature below −30 degrees Celsius.

37. A method, which optionally incorporates one or more features of any one or more of the preceding and/or following aspects, wherein the second condenser operates at a temperature of about −40 degrees Celsius.

38. A vacuum distillation system, which optionally incorporates one or more features of any one or more of the preceding and/or following aspects, comprising: a vessel for containing a product; a heating apparatus for heating the product in the vessel so as to generate a vapor; a first condenser for receiving the vapor from the vessel and generating a first condensate; a second condenser for receiving the vapor from the first condenser and generating a second condensate; and a vacuum pump for generating a vacuum pressure within the vacuum distillation system, the vacuum pump being located downstream of the second condenser; wherein the second condenser operates at a lower temperature than the first condenser.

39. A method, which optionally incorporates one or more features of any one or more of the preceding and/or following aspects, the method comprising: pressing fruit to produce fruit juice and fruit husks; separating the fruit juice from the fruit husks; boiling the fruit juice at less than atmospheric pressure to produce a concentrated fruit juice and a first vapor; passing the first vapor through at least one condenser to generate a first condensate; removing pectin from the concentrated fruit juice; macerating the fruit husks in a solution containing ethanol; boiling the ethanol at less than atmospheric pressure to produce a second vapor; passing the second vapor through at least one condenser to generate a second condensate; and combining the concentrated fruit juice, the first condensate, and the second condensate to produce a fruit juice product.

40. A method, which optionally incorporates one or more features of any one or more of the preceding and/or following aspects, wherein the fruit is a citrus fruit.

41. A method, which optionally incorporates one or more features of any one or more of the preceding and/or following aspects, wherein the fruit is lime.

42. A method, which optionally incorporates one or more features of any one or more of the preceding and/or following aspects, wherein the method is performed at a temperature that is less than 50 degrees Celsius.

43. A method, which optionally incorporates one or more features of any one or more of the preceding and/or following aspects, wherein the method is performed at a temperature that is less than 45 degrees Celsius.

44. A method, which optionally incorporates one or more features of any one or more of the preceding and/or following aspects, wherein the ethanol is boiled at a temperature that is between about 20 degrees Celsius and 45 degrees Celsius.

45. A method, which optionally incorporates one or more features of any one or more of the preceding and/or following aspects, wherein the fruit juice is boiled at a temperature that is between about 20 degrees Celsius and 45 degrees Celsius.

46. A method, which optionally incorporates one or more features of any one or more of the preceding and/or following aspects, wherein the ethanol is boiled at a pressure that is between about 2 Torr and 40 Torr.

47. A method, which optionally incorporates one or more features of any one or more of the preceding and/or following aspects, wherein the fruit juice is boiled at a pressure that is between about 2 Torr and 40 Torr.

48. A method, which optionally incorporates one or more features of any one or more of the preceding and/or following aspects, wherein the pectin is removed from the concentrated fruit juice by enzymatic processing.

49. A method, which optionally incorporates one or more features of any one or more of the preceding and/or following aspects, wherein the solution comprises water and 20% ethanol by volume.

50. A method, which optionally incorporates one or more features of any one or more of the preceding and/or following aspects, wherein the fruit husks are macerated for about 24 hours.

51. A method, which optionally incorporates one or more features of any one or more of the preceding and/or following aspects, wherein the fruit juice product is an alcoholic beverage or is incorporated into an alcoholic beverage.

52. A method, which optionally incorporates one or more features of any one or more of the preceding and/or following aspects, wherein the first condensate is a hydrosol, the method further comprising using at least some of the hydrosol to dilute an alcoholic beverage.

53. A method, which optionally incorporates one or more features of any one or more of the preceding and/or following aspects, wherein the second condensate is a fruit husk distillate, the method further comprising using at least some of the fruit husk distillate to produce an alcoholic beverage.

54. The fruit juice product produced by the method in accordance with any one or more of the preceding aspects.

55. A beverage comprising the fruit juice product produced by the method in accordance with any one or more of the preceding aspects.

56. A product comprising the first condensate and the second condensate produced by the method in accordance with any one or more of the preceding aspects.

57. A beverage comprising the first condensate and the second condensate produced by the method in accordance with any one or more of the preceding aspects.

58. A de-alcoholized beverage produced by the method in accordance with any one or more of the preceding aspects.

### BRIEF DESCRIPTION OF THE DRAWINGS

Further aspects and advantages of the invention will appear from the following description taken together with the accompanying drawings, in which:

FIG. 1 is a flowchart illustrating the overall operation of an embodiment of the invention;

FIG. 2 is block diagram illustrating an embodiment of the vacuum distillation system; and

FIG. 3 is an illustration of an embodiment of the vacuum distillation system.

### DETAILED DESCRIPTION OF THE DRAWINGS

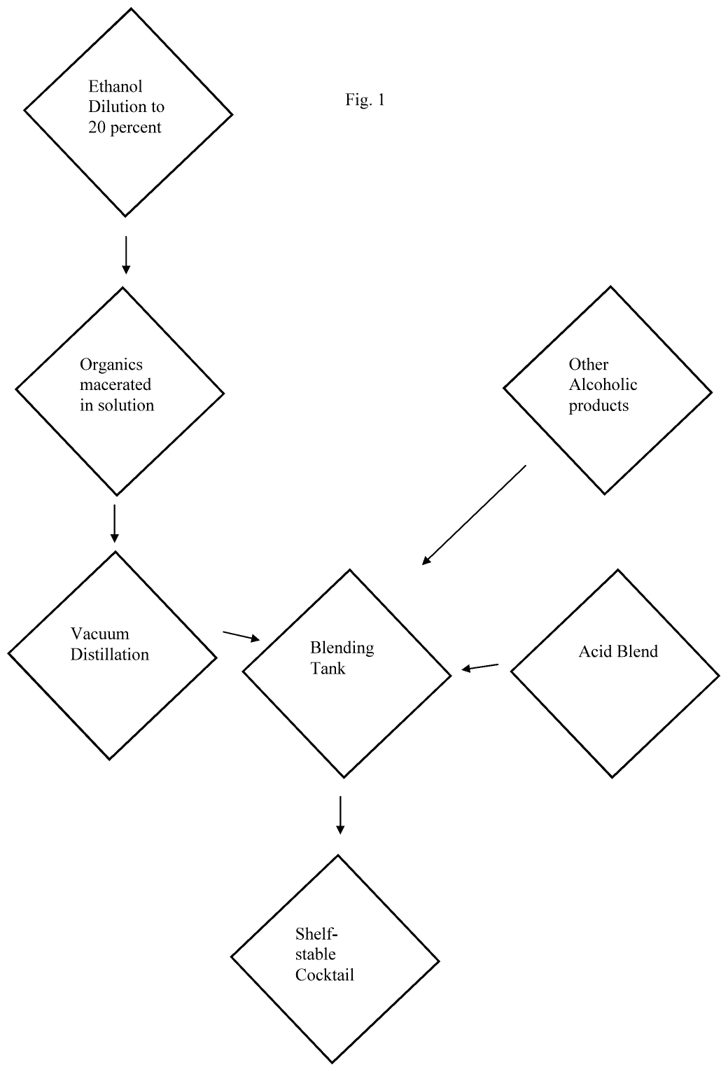

Reference is made to FIG. 1, which provides a flowchart illustrating the overall operation of an embodiment of the invention. Initially, an organic material is macerated in a solution containing 20% ethanol. A 20% ethanol solution is preferred over higher concentrations, to reduce degradation of flavor compounds that may occur at higher alcohol concentrations. Starting with a relatively dilute ethanol solution also causes the final spirit to have a lower alcohol concentration, which preferably allows the final product to require less dilution and thus be more flavorful. A relatively long maceration period of at least 48 hours is also preferred. Vacuum distillation is then used to boil off and collect the ethanol and other volatile organic compounds. The resulting spirit can then be combined with other products such as other alcoholic products or acid blends, to produce a shelf-stable cocktail. Other ingredients, such as sugars, can also be added.

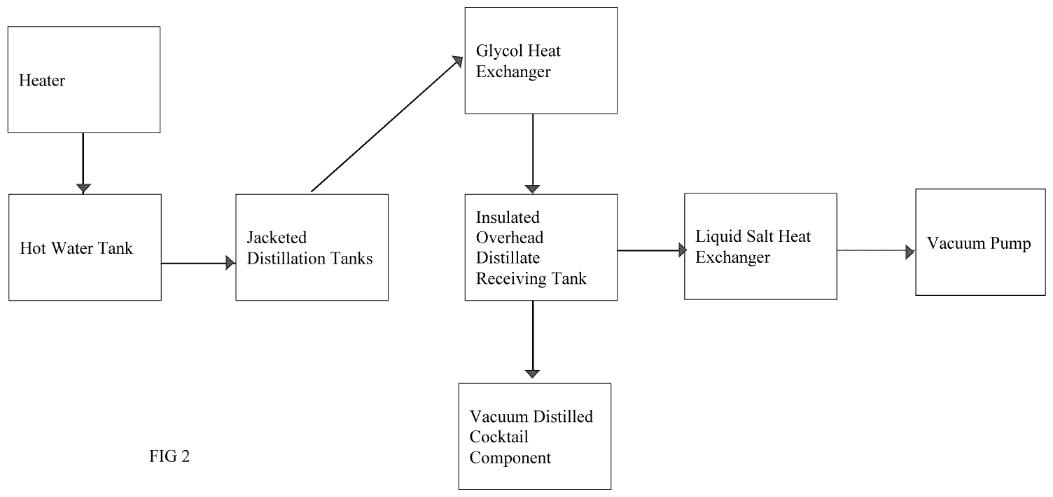

FIG. 2 shows a block diagram of an embodiment of the vacuum distillation system. A heater is used to heat water in a hot water tank, which is in turn used to heat a mixture of organic material and an ethanol solution in the jacketed distillation tanks. The ethanol and volatile organic compounds that are boiled out of the mixture travel through a glycol heat exchanger, which cools the gases to generate a first condensate. The first condensate is collected in the insulated overhead distillate receiving tank. The remaining gas travels into the liquid salt heat exchanger, which further cools the gas and condensates the remaining ethanol and volatile organic compounds as a second condensate, which is also collected in the insulated overhead distillate receiving tank. The first and second condensates can be used as a component of a cocktail. A vacuum pump is located downstream of the liquid salt heat exchanger, and generates a vacuum within the system so as to lower the boiling temperature of the ethanol.

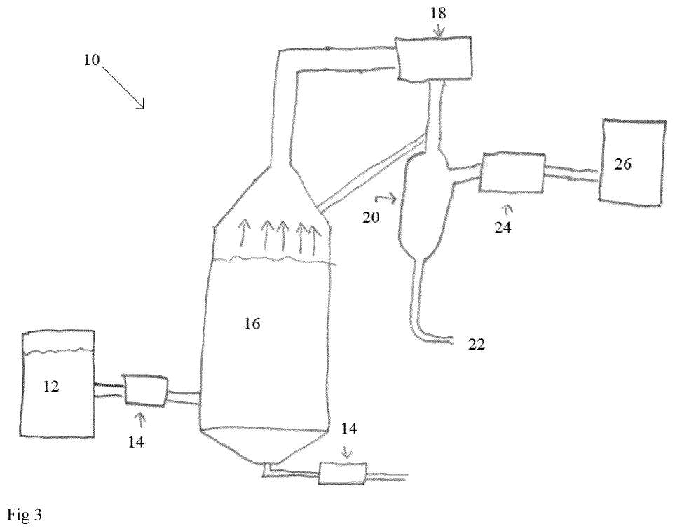

FIG. 3 shows an embodiment of the vacuum distillation system 10. The system includes a macerate tank 12, which contains an organic material macerated in a solution of 20% ethanol. After the organic material has macerated for a sufficient amount of time, preferably between about 24 and 72 hours, the liquid portion of the mixture is pumped into the vacuum still 16 via a progressive cavity pump 14. The vacuum still 16 preferably uses jacketed heating for heating the liquid mixture, and has a conical bottom. A vacuum pump 26 generates a vacuum within the system 10, so as to lower the boiling temperature of the ethanol. The liquid mixture is heated in the vacuum still 16 so as to boil off the ethanol and volatile flavor compounds, which pass through the −4 degrees Celsius glycol condenser 18. The glycol condenser 18 lowers the temperature of the gas, which causes much of the ethanol and volatile flavor compounds to condense as a first condensate, which is collected in the insulated collection tank 20. The remaining gas travels towards the −40 degrees Celsius liquid salt condenser 24, which further lowers the temperature of the gas so as to cause the remaining ethanol and volatile flavor compounds to condense as a second condensate, which is also collected in the insulated collection tank 20. The resulting spirit can be removed from the collection tank 20 at outlet 22, and used for example as a component of a shelf-stable cocktail. The remaining mixture in the vacuum still 16 can be pumped out of the still 16 via the progressive cavity pump 14.

In some embodiments of the invention, the vacuum distillation system 10 may be used to remove the alcohol from an alcoholic beverage, such as beer or wine. In these embodiments, the final product (the de-alcoholized beer or wine) is collected from the vacuum still 16 once the alcohol has been boiled off. When producing de-alcoholized beer or wine, the ethanol is preferably boiled off at a relatively low temperature, to limit the loss of flavor compounds. Preferably, the beer or wine is heated to 24 degrees Celsius or lower. In some preferred embodiments, the beer or wine is heated to about 20 degrees Celsius.

In still other embodiments of the invention, the vacuum distillation system 10 may be used to produce several different products, which can optionally be combined to produce a final product. For example, in one preferred embodiment of the invention the vacuum distillation system can be used to produce a shelf-stable fruit juice, such as lime juice. The limes are first pressed in order to generate lime juice and lime husks. The lime juice and lime husks are then separated, and the lime juice is placed in the vacuum still 16. The lime juice is then concentrated by reducing the barometric pressure within the vacuum still 16 using the vacuum pump 26, so as to boil off a vapor. The temperature within the vacuum still 16 is preferably kept low so as to avoid degradation of flavor compounds, as in the previous embodiments. The vapor is then condensed by the first and second condensers 18, 24 to produce a hydrosol. The hydrosol may, for example, be used to dilute alcoholic beverages containing lime.

The concentrated lime juice is then processed to remove pectin, preferably through enzymatic processing.

The husks are macerated in a solution containing water and ethanol, preferably 20% ethanol by volume. Preferably, the husks for macerated for about 24 hours. The macerated volume is then distilled in the vacuum still 16 at a low pressure and a low temperature. The resulting vapor is condensed by the first and second condensers 18, 24 to produce a lime husk distillate. The lime husk distillate may be used in alcoholic beverages containing lime, for example to add flavor and ethanol to the beverages.

Preferably, the concentrated lime juice, the lime husk distillate, and the lime hydrosol are combined to produce a shelf stable lime juice product, which can for example be used to add flavor and ethanol to beverages.

It is to be appreciated that the invention may be used to generate distillates from a wide variety of different organic materials, such as fruit, vegetables, chocolate, spices, beans, nuts, seeds, coffee, flowers, and other foods and/or products that contain desirable flavor compounds. In some embodiments of the invention, the resulting distillate preferably has about 40% alcohol by volume.

It will be understood that, although various features of the invention have been described with respect to one or another of the embodiments of the invention, the various features and embodiments of the invention may be combined or used in conjunction with other features and embodiments of the invention as described and illustrated herein.

Although this disclosure has described and illustrated certain preferred embodiments of the invention, it is to be understood that the invention is not restricted to these particular embodiments. Rather, the invention includes all embodiments which are functional, chemical, or mechanical equivalents of the specific embodiments and features that have been described and illustrated herein.

We claim:

1. A method comprising:
macerating an organic material in a solution containing ethanol;
boiling the ethanol at a pressure that is less than atmospheric pressure to produce a vapor;
passing the vapor through a first condenser to generate a first condensate; and
passing the vapor through a second condenser to generate a second condensate;
wherein the second condenser operates at a lower temperature than the first condenser.

2. The method according to claim 1, wherein the solution contains less than 30% ethanol by volume.

3. The method according to claim 1, wherein the solution contains about 20% ethanol by volume.

4. The method according to claim 1, wherein the organic material and the solution together form a mixture; and
wherein the organic material is less than 30% of the mixture by weight.

5. The method according to claim 1, wherein the pressure is less than 40 Torr.

6. The method according to claim 1, wherein the pressure is adjusted over time to maintain boiling of the ethanol.

7. The method according to claim 1, wherein the ethanol is boiled at a temperature that is between about 20 degrees Celsius and about 45 degrees Celsius.

8. The method according to claim 1, wherein the first condenser operates at a temperature between about 0 degrees Celsius and about −10 degrees Celsius.

9. The method according to claim 1, wherein the second condenser operates at a temperature below −30 degrees Celsius.

10. A method comprising:
pressing fruit to produce fruit juice and fruit husks;
separating the fruit juice from the fruit husks;
boiling the fruit juice at less than atmospheric pressure to produce a concentrated fruit juice and a first vapor;
passing the first vapor through at least one condenser to generate a first condensate;
removing pectin from the concentrated fruit juice;
macerating the fruit husks in a solution containing ethanol;
boiling the ethanol at less than atmospheric pressure to produce a second vapor;
passing the second vapor through at least one condenser to generate a second condensate; and
combining the concentrated fruit juice, the first condensate, and the second condensate to produce a fruit juice product.

11. The method according to claim 10, wherein the fruit is a citrus fruit.

12. The method according to claim 10, wherein the fruit is lime.

13. The method according to claim 10, wherein the method is performed at a temperature that is less than 45 degrees Celsius.

14. The method according to claim 10, wherein the ethanol is boiled at a pressure that is between about 2 Torr and 40 Torr.

15. The method according to claim 10, wherein the fruit juice is boiled at a pressure that is between about 2 Torr and 40 Torr.

16. The method according to claim 10, wherein the pectin is removed from the concentrated fruit juice by enzymatic processing.

17. The method according to claim 10, wherein the solution comprises water and 20% ethanol by volume.

18. The method according to claim 10, wherein the fruit husks are macerated for about 24 hours.

19. The fruit juice product produced by the method as claimed in claim 10.

20. A product comprising the first condensate and the second condensate produced by the method as claimed in claim 1.
